(19) United States
(12) Patent Application Publication
(10) Pub. No.: US 2017/0088696 A1
(43) Pub. Date: Mar. 30, 2017

(54) RUBBER REINFORCED WITH FILLERS DISPERSED IN FUNCTIONALIZED SILSESQUIOXANES

(71) Applicants: Rostyslav Dolog, Houston, TX (US); Radhika Suresh, Sugar Land, TX (US); Valery N. Khabashesku, Houston, TX (US)

(72) Inventors: Rostyslav Dolog, Houston, TX (US); Radhika Suresh, Sugar Land, TX (US); Valery N. Khabashesku, Houston, TX (US)

(73) Assignee: Baker Hughes Incorporated, Houston, TX (US)

(21) Appl. No.: 15/265,891

(22) Filed: Sep. 15, 2016

Related U.S. Application Data
(60) Provisional application No. 62/234,307, filed on Sep. 29, 2015.

(51) Int. Cl. C08K 9/06; C09K 8/50

(52) U.S. Cl. CPC C08K 9/06; C09K 8/50

(57) ABSTRACT

A downhole article comprises: an elastomer comprising one or more of the following: an ethylene-propylene-diene monomer rubber; a butadiene rubber; a styrene-butadiene rubber; a natural rubber; an acrylonitrile butadiene rubber; a styrene-butadiene-acrylonitrile resin; a butadiene-nitrile rubber; a polyisoprene rubber; an acrylate-butadiene rubber; a polychloroprene rubber; an acrylate-isoprene rubber; an ethylene-vinyl acetate rubber; a polypropylene oxide rubber; a polypropylene sulfide rubber; a fluoroelastomer; a perfluoroelastomer; or a thermoplastic polyurethane rubber; and a filler dispersed in a functionalized silsesquioxane having a viscosity of about 1 poise to about 40 poise at 25° C., wherein the filler is compositionally different than the functionalized silsesquioxane

### CROSS-REFERENCE TO RELATED APPLICATION

This application claims the benefit of U.S. Provisional Application Ser. No. 62/234,307, filed Sep. 29, 2015, the content of which is incorporated herein by reference in its entirety.

### BACKGROUND

Elastomers are used in applications as diverse as packer elements, blow out preventer elements, O-rings, gaskets, and the like. In downhole drilling and completion, the elastomers are often exposed to harsh chemical and mechanical subterranean environments that can degrade elastomer performance over time, reducing their reliability. Thus, in the oil and gas industry, it is desirable for the elastomer to have optimal mechanical strength so that it does not extrude during application and, when in use, an article made from the elastomer can hold differential hydraulic pressure while applied downhole.

Additives can be used to adjust the properties of the elastomers. One difficulty in developing suitable elastomeric materials for downhole applications is that use of one additive to improve one property can concomitantly degrade another desired property. For example, adding fillers to an elastomer can improve the mechanical strength of the elastomer. However, in order to achieve any meaningful improvement, fillers have to be used in a significant amount; and at a high loading level, fillers can have detrimental effects on the elasticity and compression set properties of the final rubber products. Despite all the advances, there remains a need in the art for downhole articles that have a delicate balance of mechanical strength and elasticity at high temperatures.

### BRIEF DESCRIPTION

A downhole article comprises: an elastomer comprising one or more of the following: an ethylene-propylene-diene monomer rubber; a butadiene rubber; a styrene-butadiene rubber; a natural rubber; an acrylonitrile butadiene rubber; a styrene-butadiene-acrylonitrile resin; a butadiene-nitrile rubber; a hydrogenated nitrile butadiene rubber; a carboxylated nitrile butadiene rubber; a carboxylated hydrogenated nitrile butadiene rubber; an amidated nitrile butadiene rubber; a polyisoprene rubber; an acrylate-butadiene rubber; a polychloroprene rubber; an acrylate-isoprene rubber; an ethylene-vinyl acetate rubber; a polypropylene oxide rubber; a polypropylene sulfide rubber; a fluoroelastomer; a perfluoroelastomer; or a thermoplastic polyurethane rubber; and a filler dispersed in a functionalized silsesquioxane having a viscosity of about 1 poise to about 2000 poise at 25° C., wherein the filler is compositionally different than the functionalized silsesquioxane.

A method of manufacturing a downhole article comprises dispersing the filler in the functionalized silsesquioxane to provide a dispersion; combining the dispersion with the elastomer; and shaping the combination to provide the downhole article.

A method of impeding flow comprises employing one or more of the downhole articles disclosed herein.

### BRIEF DESCRIPTION OF THE DRAWINGS

Referring now to the drawings wherein like elements are numbered alike in the several Figures:

FIG. 1 illustrates the crosslinking of functionalized POSS with NBR/HNBR using a peroxide as the linking agent;

FIG. 2 illustrates the crosslinking of functionalized POSS with carboxylated NBR/HNBR; and

FIG. 3 show stress-strain curves of various samples containing an elastomer and a filler composition.

### DETAILED DESCRIPTION

In order to take advantage of the size, surface area, and aspect ratio of fillers, they have to be dispersed properly, which is often a challenge. Functionalized silsesquioxanes, particularly those that are viscous oils, can act as an effective dispersing media and significantly improve the reinforcing effects of fillers in elastomers. In addition, functionalized silsesquioxanes themselves can provide further reinforcement to elastomers. Due to the improved efficiency, optimal mechanical properties can be achieved with a much smaller amount of fillers. Reduced filler amounts minimizes any adverse effects that fillers may have to the elastic properties. Accordingly, downhole articles with balanced mechanical strength and elasticity can be manufactured.

Silsesquioxanes, also referred to as polysilsesquioxanes, polyorganosilsesquioxanes, or polyhedral oligomeric silsesquioxanes (POSS), are polyorganosilicon oxide compounds of general formula RSiO_{1.5} (where R is a hydrogen, inorganic group, or organic group such as methyl) having defined closed or open cage structures (closo or nido structures, which are called respectively completely condensed or incompletely structures). Silsesquioxanes can be prepared by acid and/or base-catalyzed condensation of functionalized silicon-containing monomers such as tetraalkoxysilanes including tetramethoxysilane and tetraethoxysilane, alkyltrialkoxysilanes such as methyltrimethoxysilane and methyltriethoxysilane.

Silsesquioxanes can have a closed cage structure, an open cage structure, or a combination comprising at least one of the foregoing. The shape of the cage structure is not limited and includes cubes, hexagonal prisms, octagonal prisms, decagonal prisms, dodecagonal prisms, and the like. Additionally, the cage structure of the silsesquioxane comprises from 4 to 30 silicon atoms, specifically, 4 to 20 silicon atoms, and more specifically 4 to 16 silicon atoms, with each silicon atom in the cage structure being bonded to oxygen. It should be noted that the term “cage structure” is meant to include the SiOi 5 portion of the general silsesquioxane formula RSiO_{1.5}, and not the R-group.

Functionalized silsesquioxanes comprise a functional group bonded to a silicone atom of the silsesquioxanes. In a specific embodiment, the functional group bonded to the silicon atom comprises an alkyl, alkoxy, haloakyl, cycloalkyl, heterocycloalkyl, cycloalkyloxy, aryl, aralkyl, aryloxy, aralkyloxy, heteroaryl, heteroaralkyl, alkenyl, alkynyl, amine, alkyleneamine, aryleneamine, alkenyleneamine, hydroxy, sulfonate, carboxyl, ether, epoxy, ketone, halogen, hydrogen, or combination comprising at least one of the foregoing. In some embodiments, the functionalized silsesquioxanes are derivatized with a functional group including an alcohol, amine, carboxylic acid, epoxy, ether, fluoroalkyl, halide, imide, ketone, methacrylate, acrylate, isocyanate, sulfonate, nitrile, norbornenyl, olefin, polyethylene glycol (PEG), silane, silanol, sulfonate, thiol, and the like. In a specific embodiment, the functionalized silsesquioxanes have methacrylate groups. The functionalized silsesquioxane can have from one functional group to as many functional groups as there are silicon atoms in the cage structure of the silsesquioxane.

In an embodiment, the silsesquioxanes are derivatized by, for example, amination to include amine groups, where amination may be accomplished by nitration followed by reduction, or by nucleophilic substitution of a leaving group by an amine, substituted amine, or protected amine, followed by deprotection as necessary. In another embodiment, silsesquioxanes can be derivatized by oxidative methods to produce an epoxy, hydroxy group or glycol group using a peroxide, or as applicable by cleavage of a double bond by for example a metal mediated oxidation such as a permanganate oxidation to form ketone, aldehyde, or carboxylic acid functional groups.

Where the functional groups are alkyl, aryl, aralkyl, alkaryl, or a combination of these groups, the functional groups can be attached directly to the derivatized silsesquioxane by a carbon-carbon bond (or carbon-silicon bond for silsesquioxanes) without intervening hetero atoms, to provide greater thermal and/or chemical stability, to the derivatized silsesquioxane, as well as a more efficient synthetic process requiring fewer steps; by a carbon-oxygen (or silicon-oxygen for silsesquioxanes) bond (where the silsesquioxane contains an oxygen-containing functional group such as hydroxy or carboxylic acid); or by a carbon-nitrogen (or silicon-nitrogen for silsesquioxanes) bond (where the silsesquioxane contains a nitrogen-containing functional group such as amine or amide). In an embodiment, the silsesquioxanes are derivatized by metal mediated reaction with a C₆₋₃₀ aryl or C₇₋₃₀ aralkyl halide (F, Cl, Br, I) in a carbon-carbon (or silicon-carbon) bond forming step, such as by a palladium-mediated reaction such as the Stille reaction, Suzuki coupling, or diazo coupling, or by an organocopper coupling reaction. In another embodiment, silsesquioxanes are directly metallated by reaction with, e.g., an alkali metal such as lithium, sodium, or potassium, followed by reaction with a C₁₋₃₀ alkyl or C₇₋₃₀ alkaryl compound with a leaving group such as a halide (Cl, Br, I) or other leaving group (e.g., tosylate, mesylate, etc.) in a carbon-carbon bond forming step. The aryl or aralkyl halide, or the alkyl or alkaryl compound, can be substituted with a functional group such as hydroxy, carboxy, ether, or the like.

In some embodiments, the functionalized silsesquioxanes are oil-like at room temperature. They can have a viscosity of about 1 poise to about 2000 poise at 25° C., or about 20 poise to about 1000 poise at 25° C., or about 50 poise to about 400 poise at 25° C. The liquid functionalized silsesquioxanes can act as dispersant for a filler that is compositionally different from the functionalized silsesquioxane. (also referred to as the “second filler.”)

Exemplary second fillers include clays, fly ash, carbon black, carbon based nanomaterials such as graphite, graphene, graphene oxides, reduced graphene oxide, carbon nanotubes, nanosprings, carbon nano-onions, fullerenes, or a combination comprising at least one of the foregoing. These fillers can be functionalized to further improve their compatibility with functionalized POSS. The functional groups for the second fillers include carboxy (e.g., carboxylic acid groups), epoxy, ether, ketone, aminol, hydroxy, alkoxy, alkyl, aryl, aralkyl, alkaryl, lactone, functionalized polymeric or oligomeric groups, or a combination comprising at least one of the forgoing functional groups.

Clays such as nanoclays and organoclays are specifically mentioned. Nanoclays are nanoparticles of layered mineral silicates. Depending on the chemical composition and the nanoparticle morphology, nanoclays can be grouped into several classes such as montmorillonite, bentonite, kaolinite, hectorite, and halloysite. Organoclay is an organically modified phyllosilicate. By exchanging the original interlayer cations for organocations for example quaternary alkylammonium ions, an organophilic surface is generated consisting essentially of covalently linked organic moieties.

In an embodiment the second filler comprises an organoclay such as montmorillonite modified with a quaternary ammonium salt. In another embodiment, the second filler comprises a combination of carbon black and an organoclay such as montmorillonite modified with a quaternary ammonium salt.

Optionally, the functionalized POSS is bonded to the second filler. In one embodiment, the functionalized POSS can react with the second filler to form the bond therebetween. In a particular embodiment, the functionalized POSS and second filler are bonded via a functional group.

A ratio of the weight of the functionalized POSS to that of the second filler is about 30:1 to about 1:3, specifically about 20:1 to about 1:1, more specifically about 15:1 to about 2:1, and even more specifically about 10:1 to about 3:1. When the filler comprises carbon black and montmorillonite modified with a quaternary ammonium salt, the weight ratio of carbon black relative to montmorillonite modified with a quaternary ammonium salt is about 50:1 to about 1:3 or about 30:1 to about 2:1 or about 25:1 to about 5:1. The functionalized POSS can be present in the downhole article in an amount from about 0.1 wt % to about 30 wt %, specifically about 0.1 wt % to about 20 wt %, and more specifically about 0.1 wt % to about 10 wt %, based on a weight of the downhole article. The second filler can be present in the downhole article in an amount from about 0.1 wt % to about 60 wt %, specifically about 0.1 wt % to about 30 wt %, and more specifically about 0.1 wt % to about 20 wt %, based on a weight of the downhole article.

The elastomer in the downhole article is one or more of the following: an ethylene-propylene-diene monomer rubber; a butadiene rubber; a styrene-butadiene rubber; a natural rubber; an acrylonitrile butadiene rubber; a styrene-butadiene-acrylonitrile resin; a butadiene-nitrile rubber; a hydrogenated nitrile butadiene rubber; a carboxylated nitrile butadiene rubber; a carboxylated hydrogenated nitrile butadiene rubber; an amidated nitrile butadiene rubber; a polyisoprene rubber; an acrylate-butadiene rubber; a polychloroprene rubber; an acrylate-isoprene rubber; an ethylene-vinyl acetate rubber; a polypropylene oxide rubber; a polypropylene sulfide rubber; a fluoroelastomer; a perfluoroelastomer; or a thermoplastic polyurethane rubber. Preferably, the elastomer comprises one or more of the following: an ethylene-propylene-diene monomer rubber; a natural rubber; an acrylonitrile butadiene rubber; or a fluoroelastomer.

Exemplary fluoroelastomers include high fluorine content fluoroelastomers rubbers such as those in the FKM family and marketed under the tradename VITON® (available from FKM-Industries) and perfluoroelastomers such as FFKM (also available from FKM-Industries) and marketed under the tradename KALREZ® perfluoroelastomers (available from DuPont) and FEPM (Tetrafluoroethylene/propylene) marketed under the tradename AFLAS.

Nitrile butadiene rubber (NBR) is a family of unsaturated copolymers of 2-propenenitrile and various butadiene monomers (1,2-butadiene and 1,3-butadiene). Although its physical and chemical properties vary depending on the elastomer base polymer's content of acrylonitrile (the more acrylonitrile within the elastomer base polymer, the higher the resistance to oils but the lower the flexibility of the material), this form of synthetic rubber is generally resistant to oil, fuel, and other chemicals. Derivatives of NBR can also be used as the elastomer base polymer, for example, hydrogenated NBR (HNBR), carboxylated NBR (XNBR), carboxylated hydrogenated NBR (XHNBR), and NBR with some of the nitrile groups substituted by an amide group (referred to as amidated NBR or ANBR). Suitable, but non-limiting examples of NBR and its derivatives include, but are not limited to NIPOL™ 1014 NBR available from Zeon Chemicals, LP; Perbunan NT-1846 from LanXess or N22L from JSR. In a specific embodiment, the polymer comprises NBR and HNBR.

The elastomers can further be chemically modified to include functional groups such as halogen, hydroxyl, amino, ether, ester, amide, sulfonate, or carboxyl, or can be oxidized or hydrogenated. In an embodiment, the elastomer comprises carboxylated NBR and/or carboxylated HNBR.

The elastomers are present in an amount of about 35 wt. % to about 95 wt. % or about 60 wt.% to about 90 wt.% or about 70 wt.% to about 85 wt.% based on the total weight of the downhole article.

In an embodiment, the functionalized POSS is bonded to the elastomer or reactive functional groups that may be present in the elastomer. Such bonding between the functionalized POSS and elastomer improves tethering of the functionalized POSS with the elastomer. In an embodiment, the functionalized POSS and the second filler are both bonded to the elastomer.

The functionalized POSS can be bonded to the elastomer via a crosslinking agent. The crosslinking agent is for example elemental sulfur, sulfur donor, silica, a quinone, a peroxy compound, a metal oxide, a metal salt, oxygen, or a combination comprising at least one of the foregoing crosslinking agent. Exemplary quinones include p-benzoquinone, tetramethylbenzoquinone, naphthoquinone, and the like. Peroxy compounds useful as crosslinking agents include alkyl or aryl diperoxy compounds, and metal peroxides. Exemplary aryl diperoxy compounds include those based on dicumyl peroxide (DCP) and marketed by Arkema, Inc. under the tradename DI-CUP including, DI-CUP dialkyl peroxide, DI-CUP 40C dialkyl peroxide (on calcium carbonate support), DI-CUP 40K dialkyl peroxide, DI-CUP 40KE dialkyl peroxide; and alkyl diperoxy compounds including 2,5-dimethyl-2,5-di(t-butylperoxy) hexane and marketed by Akzo-Nobel under the tradename TRIGONOX 101. Exemplary metal peroxides include magnesium peroxide, calcium peroxide, zinc peroxide, or the like, or a combination comprising at least one of the foregoing. Metal oxides useful as crosslinking agents include, for example, zinc oxide, magnesium oxide, titanium dioxide, or the like, or a combination comprising at least one of the foregoing. Examples of sulfur donor agents include alkyl polysulfides, thiuram disulfides, and amine polysulfides. Some non-limiting examples of suitable sulfur donor agents are 4,4′-dithiomorpholine, dithiodiphosphorodisulfides, diethyldithiophosphate polysulfide, alkyl phenol disulfide, tetramethylthiuram disulfide, 4-morpholinyl-2-benzothiazole disulfide, dipentamethylenethiuram hexasulfide, and caprolactam disulfide. Suitable metal salts include ammonium zirconium carbonate, potassium zirconium carbonate, and zinc acetate. As an example, carboxylated POSS particles can be chemically crosslinked with carboxylic groups of a carboxylated NBR/HNBR by salts or oxides of multivalent cations, including but not limited to Zn, Mg, Al, Fe, Ti, and Zr.

Effective amounts of crosslinking agents can be readily determined by one of ordinary skill in the art depending on factors such as the reactivity of the peroxide, functionalized POSS, and the elastomer, the desired degree of crosslinking, and like considerations, and can be determined without undue experimentation. For example, the crosslinking agent can be used in amounts of about 0.1 to about 12 parts, or about 0.5 to 5 parts, or about 0.5 to 3 parts, per 100 parts or about by weight of the elastomer.

In a specific embodiment, both the functionalized POSS and the elastomer have carboxyl or sulfonate functional groups and they are crosslinked through metal cations such as zinc cations. In another embodiment, the functionalized POSS has an alkyl functional group, optionally containing unsaturated bonds, and it can be crosslinked to the elastomer via oxygen, peroxide, or sulfur crosslinking agents. In yet another embodiment, the functionalized POSS contains epoxy groups, which can be chemically crosslinked with amino groups present in the elastomer. It is appreciated that the functionalized POSS can contain amino groups, which are chemically crosslinked with epoxy groups present in the elastomer. In still another embodiment, the functionalized POSS has isocyanate groups which can be crosslinked with amino or hydroxyl groups of the elastomer.

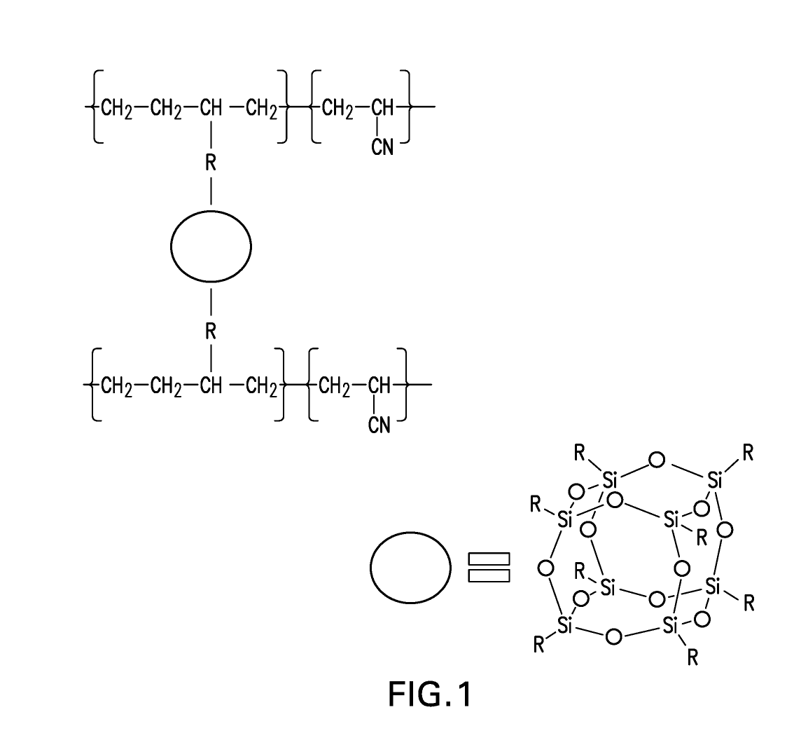

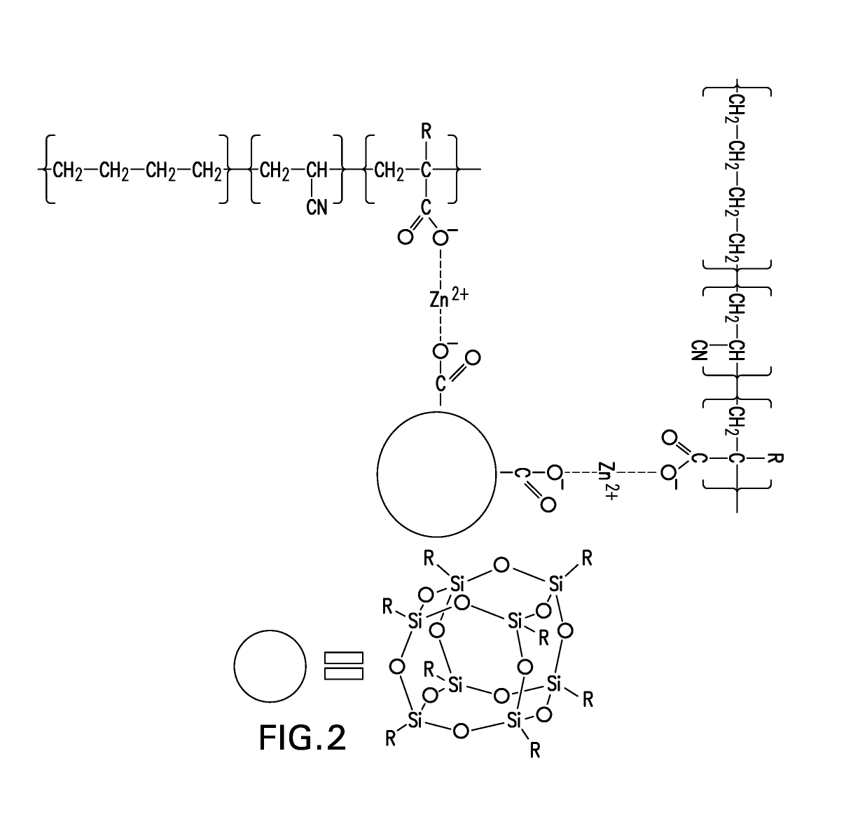

FIG. 1 illustrates the crosslinking of functionalized POSS with NBR/HNBR using a peroxide as the linking agent; and FIG. 2 illustrates the crosslinking of functionalized POSS with carboxylated NBR/HNBR. In FIGS. 1 and 2, R is the same as R defined in the context of silsesquioxane.

To adjust the properties of the downhole article (e.g. improve compression set, decrease cost), a blend of carboxylated NBR/HNBR with regular NBR/HNBR can be used. Both the carboxylated NBR/HNBR and regular NBR/HNBR can be cured together by peroxide and/or sulfur curing system, while the carboxylated component can also be chemically linked to functionalized POSS particles via metal cations.

A process of making the downhole article includes dispersing the filler in the functionalized POSS to provide a dispersion, combining the dispersion with the elastomer; and shaping the combination to provide the downhole tool. Dispersing can be conducted in various mixers, including, blends, Thinky Mixer, centrifuge, continuous flow mixers, solid-liquid injection manifolds. Sonication is optionally used to ensure that a homogeneous dispersion is formed. Shaping includes molding, extruding, casting, foaming, and the like.

In an embodiment, the elastomer and the dispersion are compounded with an additive prior to shaping. “Additive” as used herein includes any compound added to the combination of the elastomer and the dispersion of a filler in a functionalized POSS to adjust the properties of the downhole article, for example a crosslinking agent or processing aid, provided that the additive does not substantially adversely impact the desired properties of the downhole article.

A processing aid is a compound included to improve flow, moldability, and other properties of the elastomer. Processing aids include, for example an oligomer, a wax, a resin, a fluorocarbon, or the like. Exemplary processing aids include stearic acid and derivatives, low molecular weight polyethylene, and the like. Combinations comprising at least one of the foregoing processing aids can be used.

In an embodiment, a downhole article is manufactured by dispersing the filler in the functionalized POSS to provide a dispersion, combining the dispersion with the elastomer and a crosslinking agent; shaping the combination; and crosslinking the functionalized POSS and the elastomer to form the article. Shaping and crosslinking can occur simultaneously or sequentially.

Crosslinking conditions include a temperature or pressure effective to bond the functionalized silsesquioxane to the elastomer. In an embodiment, the temperature is 25° C. to 250° C., and specifically 50° C. to 175° C. The pressure can be less than 1 atmosphere (atm) to 200 atm, specifically 1 atm to 100 atm. A catalyst can be added to increase the reaction rate of bonding the functionalized silsesquioxane to the elastomer. In an embodiment, a functional group on the cage structure of the silsesquioxane is bonded directly to the elastomer. In another embodiment, a functional group attached to the silsesquioxane is boned to the functional group on the elastomer.

The degree of crosslinking can be regulated by controlling reaction parameters such as crosslinking temperature, crosslinking time, and crosslinking environment, for example, varying the relative amounts of the elastomer, the functionalized POSS, and the crosslinking agent and curing coagents. Other additive coagents may be used to control the scorch time of the rubber compound, crosslinking mechanism and the properties of resulting crosslinks

The downhole articles of the disclosure have improved mechanical properties, reliability, and environmental stability. The articles can be a single component article. In an embodiment, the downhole articles inhibit flow. In another embodiment, the downhole articles are pumpable within a downhole environment. The pumpable articles can also be referred to as “hydraulically displaced articles.”

Illustrative articles that inhibit flow include seals, compression packing elements, expandable packing elements, O-rings, bonded seals, bullet seals, sub-surface safety valve seals, sub-surface safety valve flapper seal, dynamic seals, V-rings, back up rings, drill bit seals, electric submersible pump seals, blowout preventer seals

Illustrative articles that are pumpable within a downhole environment include plugs, bridge plugs, wiper plugs, frac plugs, components of frac plugs, polymeric plugs, disappearing wiper plugs, cementing plugs, swabbing element protectors, buoyant recorders, pumpable collets.

In an embodiment, the element is a packer element, a blow out preventer element, a submersible pump motor protector bag, a sensor protector, a sucker rod, an O-ring, a T-ring, a gasket, a sucker rod seal, a pump shaft seal, a tube seal, a valve seal, a seal for an electrical component, an insulator for an electrical component, a seal for a drilling motor, a seal for a drilling bit, or porous media such as a sand filter, or other downhole elements.

### EXAMPLES

The samples tested are described in Table 1. All samples were mixed in Brabender at 60 RPM. Tinky Mixer was used at 2000 RPM for 15 minutes under vacuum (about 3 kPa) to premix CLOISITE 30B powder with viscous M-POSS to form a dispersion.

TABLE 1

| Components | P1 (phr) | P2 (phr) | P3 (phr) | F6 (phr) | T5 (phr) |
|---|---|---|---|---|---|
| HNBR (THERBAN AT 3404 from Lanxess) | 100 | 100 | 100 | 100 | 100 |
| N550 carbon black | 50 | 0 | 0 | 50 | 50 |
| CLOISITE 30 B (a natural montmorillonite | 1.9 | 4.6 | 4.6 | 6.3 | 0 |
| modified with a quaternary ammonium salt) | | | | | |
| M-POSS (POSS functionalized with | 5.6 | 13.8 | 0 | 18.7 | 0 |
| methacrylate groups) | | | | | |

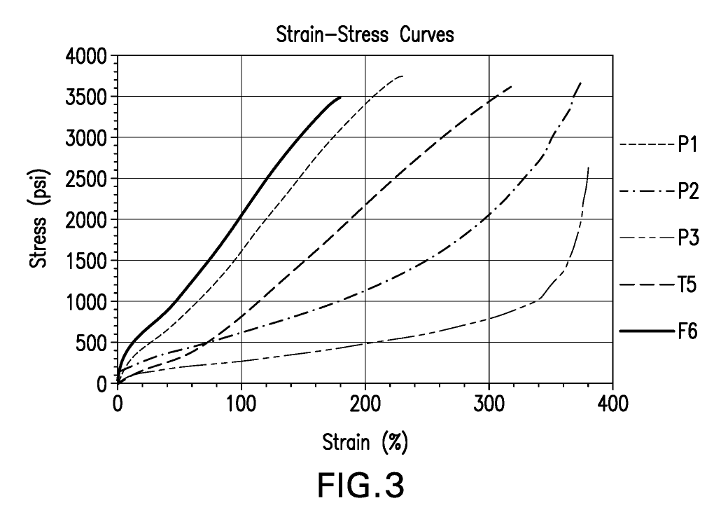

Mechanical properties of the samples P1-P3, F6 and T5 were assessed via tensile test using MTS Criterion System and TechPro with 1 kN load cell and digital extensometer, and Shore A Durometer. Samples were compression molded into slabs and buttons. ISO 37/2 die was used to cut tensile bars. Five specimens were tested per sample. The tensile bars were pulled at 20 in/min speed. Results are summarized in Table 2. Stress-strain curves are provided in FIG. 3.

TABLE 2

| | | | | | Tensile | | |
|---|---|---|---|---|---|---|---|
| | | E₂₅ | E₅₀ | E₁₀₀ | strength | Elongation | Hardness |
| Sample | Value | (psi) | (psi) | (psi) | (psi) | (%) | (Shore A) |
| P1 | Average | 466 | 770 | 1611 | 3481 | 213 | 78 |
| | SD | 27 | 42 | 75 | 226 | 21 | |
| P2 | Average | 299 | 404 | 597 | 3097 | 351 | 69 |
| | SD | 25 | 36 | 54 | 349 | 20 | |
| P3 | Average | 142 | 195 | 277 | 2319 | 371 | 55 |
| | SD | 7 | 7 | 9 | 430 | 15 | |
| F6 | Average | 668 | 1040 | 2031 | 3510 | 184 | 88 |
| | SD | 50 | 82 | 137 | 100 | 7 | |
| T5 | Average | 165 | 273 | 744 | 3402 | 290 | 68 |
| | SD | 9 | 12 | 31 | 186 | 21 | |

The results indicate that dispersions of clay in functionalized POSS provides a good reinforcing solution. Functionalized POSS itself acts as reinforcing filler. In addition, it serves as dispersing aid for another filler—CLOISITE 30 B. Compared to P3, sample P2 demonstrates great improvement in all mechanical properties, and is still capable of achieving comparable maximum elongation.

Without wishing to be bound by theory, it is believed that the significant improvement in modulus of P1 and F6 over T5 is due to the use of a dispersion of CLOISITE in M-POSS. The process optimization may also attribute to the modulus improvement. Compared to most of the T series samples, samples of P and F series were mixed for shorter period of time (about 15 minutes versus 25 minutes), but at higher screw speed (60 RPM versus 40 RPM), which helps to prevent damage to the polymer chains during mixing.

Set forth below are various embodiments of the disclosure.

Embodiment 1 A downhole article comprising:

an elastomer comprising one or more of the following: an ethylene-propylene-diene monomer rubber; a butadiene rubber; a styrene-butadiene rubber; a natural rubber; an acrylonitrile butadiene rubber; a styrene-butadiene-acrylonitrile resin; a butadiene-nitrile rubber; a hydrogenated nitrile butadiene rubber; a carboxylated nitrile butadiene rubber; a carboxylated hydrogenated nitrile butadiene rubber; an amidated nitrile butadiene rubber; a polyisoprene rubber; an acrylate-butadiene rubber; a polychloroprene rubber; an acrylate-isoprene rubber; an ethylene-vinyl acetate rubber; a polypropylene oxide rubber; a polypropylene sulfide rubber; a fluoroelastomer; perfluoroelastomer; or a thermoplastic polyurethane rubber; and

a filler dispersed in a functionalized silsesquioxane having a viscosity of about 1 poise to about 2000 poise at 25° C., wherein the filler is compositionally different than the functionalized silsesquioxane.

Embodiment 2 The downhole article of Embodiment 1, wherein the functionalized silsesquioxane is crosslinked with the elastomer.

Embodiment 3 The downhole article of Embodiment 1 or Embodiment 2, wherein the functionalized silsesquioxane has a functional group comprising one or more of the following: an alcohol; amine; carboxylic acid; epoxy; ether; fluoroalkyl; halide; imide; ketone; methacrylate; acrylate; isocyanate, nitrile; norbornenyl; olefin; polyethylene glycol; silane; silanol; sulfonate; or thiol.

Embodiment 4. The downhole article of Embodiment 3, wherein the functionalized silsesquioxane comprises methacrylate functional groups.

Embodiment 5. The downhole article of any one of Embodiments 1 to 4, wherein the filler comprises one or more of the following: carbon black; clay; or a carbon based nanomaterial.

Embodiment 6. The downhole article of Embodiment 5, wherein the filler comprises nanoclay, organoclay, or a combination comprising at least one of the foregoing.

Embodiment 7. The downhole article of any one of Embodiments 1 to 6, wherein the filler comprises carbon black and organoclay.

Embodiment 8. The downhole article of any one of Embodiments 1 to 7, wherein the weight ratio of the functionalized silsesquioxane relative to the filler is about 30:1 to about 1:3.

Embodiment 9. The downhole article of any one of Embodiments 1 to 8, wherein the elastomer comprises one or more of the following: an ethylene-propylene-diene monomer rubber; a natural rubber; an acrylonitrile butadiene rubber; a hydrogenated nitrile butadiene rubber; a fluoroelastomer; or a perfluoroelastomer.

Embodiment 10. The downhole article of any one of Embodiments 1 to 9, wherein the functionalized silsesquioxane comprises a carboxyl group or sulfonate group crosslinked with a carboxyl group or sulfonate group present on the elastomer via a metal cation.

Embodiment 11. The downhole article of any one of Embodiments 1 to 10, wherein the functionalized silsesquioxane comprises an alkyl group crosslinked with the elastomer using a peroxide, oxygen, or sulfur as a crosslinking agent.

Embodiment 12. The downhole article of any one of Embodiments 1 to 10, wherein the functionalized silsesquioxane is crosslinked with the elastomer via an epoxy group on the functionalized silsesquioxane and an amino group on the elastomer or via an amino group on the functionalized silsesquioxane and an epoxy group on the elastomer.

Embodiment 13. The downhole article of any one of Embodiments 1 to 10, wherein the functionalized silsesquioxane comprises an isocyanate group crosslinked with an amino or hydroxyl group present on the elastomer.

Embodiment 14. The downhole article of any one of Embodiments 1 to 13, wherein the downhole article inhibits flow; and the downhole article is selected from the group consisting of seals, compression packing elements, expandable packing elements, O-rings, bonded seals, bullet seals, sub-surface safety valve seals, sub-surface safety valve flapper seal, dynamic seals, V-rings, back up rings, drill bit seals, and electric submersible pump seals, and blowout preventer seals.

Embodiment 15. The downhole article of any one of Embodiments 1 to 13, wherein the downhole article is pumpable within a downhole environment; and the downhole article is selected from the group consisting of plugs, bridge plugs, wiper plugs, frac plugs, components of frac plugs, polymeric plugs, disappearing wiper plugs, cementing plugs, swabbing element protectors, buoyant recorders, and pumpable collets.

Embodiment 16. A method of manufacturing a downhole article, the method comprising:

dispersing a filler in a functionalized silsesquioxane to provide a dispersion;

combining the dispersion with an elastomer; and

shaping the combination to provide the downhole article;

wherein the elastomer comprises one or more of the following: an ethylene-propylene-diene monomer rubber; a butadiene rubber; a styrene-butadiene rubber; a natural rubber; an acrylonitrile butadiene rubber; a styrene-butadiene-acrylonitrile resin; a butadiene-nitrile rubber; a hydrogenated nitrile butadiene rubber; a carboxylated nitrile butadiene rubber; a carboxylated hydrogenated nitrile butadiene rubber; an amidated nitrile butadiene rubber; a polyisoprene rubber; an acrylate-butadiene rubber; a polychloroprene rubber; an acrylate-isoprene rubber; an ethylene-vinyl acetate rubber; a polypropylene oxide rubber; a polypropylene sulfide rubber; a fluoroelastomer; a perfluoroelastomer; or a thermoplastic polyurethane rubber; and
the functionalized silsesquioxane has a viscosity of about 1 poise to about 2000 poise at 25° C.

Embodiment 17. The method of Embodiment 16, wherein the dispersion is combined with the elastomer and a crosslinking agent.

Embodiment 18. The method of Embodiment 16 or Embodiment 17, wherein the method further comprises crosslinking the functionalized silsesquioxane and the elastomer.

Embodiment 19. The method of Embodiment 17, wherein the crosslinking agent comprises one or more of the following: sulfur; a sulfur donor; silica; a quinone; a peroxy compound; a metal oxide, a metal peroxide, or a metal salt.

Embodiment 20. A method of inhibiting flow comprising employing one or more of the downhole article of any one of Embodiments 1 to 15.

Embodiment 21. The method of Embodiment 20 comprising deploying the downhole article in a downhole environment.

All ranges disclosed herein are inclusive of the endpoints, and the endpoints are independently combinable with each other. As used herein, “combination” is inclusive of blends, mixtures, alloys, reaction products, and the like. All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” Further, it should further be noted that the terms “first,” “second,” and the like herein do not denote any order, quantity (such that more than one, two, or more than two of an element can be present), or importance, but rather are used to distinguish one element from another. The modifier “about” used in connection with a quantity is inclusive of the stated value and has the meaning dictated by the context (e.g., it includes the degree of error associated with measurement of the particular quantity). Unless defined otherwise, technical and scientific terms used herein have the same meaning as is commonly understood by one of skill in the art to which this invention belongs. As used herein, the size or average size of the particles refers to the largest dimension of the particles and can be determined by high resolution electron or atomic force microscope technology.

All references cited herein are incorporated by reference in their entirety. While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

What is claimed is:

1. A downhole article comprising:
an elastomer comprising one or more of the following: an ethylene-propylene-diene monomer rubber; a butadiene rubber; a styrene-butadiene rubber; a natural rubber; an acrylonitrile butadiene rubber; a styrene-butadiene-acrylonitrile resin; a butadiene-nitrile rubber; a hydrogenated nitrile butadiene rubber; a carboxylated nitrile butadiene rubber; a carboxylated hydrogenated nitrile butadiene rubber; an amidated nitrile butadiene rubber; a polyisoprene rubber; an acrylate-butadiene rubber; a polychloroprene rubber; an acrylate-isoprene rubber; an ethylene-vinyl acetate rubber; a polypropylene oxide rubber; a polypropylene sulfide rubber; a fluoroelastomer; perfluoroelastomer; or a thermoplastic polyurethane rubber; and
a filler dispersed in a functionalized silsesquioxane having a viscosity of about 1 poise to about 2000 poise at 25° C., wherein the filler is compositionally different than the functionalized silsesquioxane.

2. The downhole article of claim 1, wherein the functionalized silsesquioxane is crosslinked with the elastomer.

3. The downhole article of claim 1, wherein the functionalized silsesquioxane has a functional group comprising one or more of the following: an alcohol; amine; carboxylic acid; epoxy; ether; fluoroalkyl; halide; imide; ketone; methacrylate; acrylate; isocyanate, nitrile; norbornenyl; olefin; polyethylene glycol; silane; silanol; sulfonate; or thiol.

4. The downhole article of claim 3, wherein the functionalized silsesquioxane comprises methacrylate functional groups.

5. The downhole article of claim 1, wherein the filler comprises one or more of the following: carbon black; clay; or a carbon based nanomaterial.

6. The downhole article of claim 5, wherein the filler comprises nanoclay, organoclay, or a combination comprising at least one of the foregoing.

7. The downhole article of claim 1, wherein the filler comprises carbon black and organoclay.

8. The downhole article of claim 1, wherein the weight ratio of the functionalized silsesquioxane relative to the filler is about 30:1 to about 1:3.

9. The downhole article of claim 1, wherein the elastomer comprises one or more of the following: an ethylene-propylene-diene monomer rubber; a natural rubber; an acrylonitrile butadiene rubber; a hydrogenated nitrile butadiene rubber; a fluoroelastomer; or a perfluoroelastomer.

10. The downhole article of claim 2, wherein the functionalized silsesquioxane comprises a carboxyl group or sulfonate group crosslinked with a carboxyl group or sulfonate group present on the elastomer via a metal cation.

11. The downhole article of claim 2, wherein the functionalized silsesquioxane comprises an alkyl group crosslinked with the elastomer using a peroxide, oxygen, or sulfur as a crosslinking agent.

12. The downhole article of claim 2, wherein the functionalized silsesquioxane is crosslinked with the elastomer via an epoxy group on the functionalized silsesquioxane and an amino group on the elastomer or via an amino group on the functionalized silsesquioxane and an epoxy group on the elastomer.

13. The downhole article of claim 2, wherein the functionalized silsesquioxane comprises an isocyanate group crosslinked with an amino or hydroxyl group present on the elastomer.

14. The downhole article of claim 1, wherein the downhole article inhibits flow; and the downhole article is selected from the group consisting of seals, compression packing elements, expandable packing elements, O-rings, bonded seals, bullet seals, sub-surface safety valve seals, sub-surface safety valve flapper seal, dynamic seals, V-rings, back up rings, drill bit seals, and electric submersible pump seals, and blowout preventer seals.

15. The downhole article of claim 1, wherein the downhole article is pumpable within a downhole environment; and the downhole article is selected from the group consisting of plugs, bridge plugs, wiper plugs, frac plugs, components of frac plugs, polymeric plugs, disappearing wiper plugs, cementing plugs, swabbing element protectors, buoyant recorders, and pumpable collets.

16. A method of manufacturing a downhole article, the method comprising:
dispersing a filler in a functionalized silsesquioxane to provide a dispersion;
combining the dispersion with an elastomer; and
shaping the combination to provide the downhole article;
wherein the elastomer comprises one or more of the following: an ethylene-propylene-diene monomer rubber; a butadiene rubber; a styrene-butadiene rubber; a natural rubber; an acrylonitrile butadiene rubber; a styrene-butadiene-acrylonitrile resin; a butadiene-nitrile rubber; a hydrogenated nitrile butadiene rubber; a carboxylated nitrile butadiene rubber; a carboxylated hydrogenated nitrile butadiene rubber; an amidated nitrile butadiene rubber; a polyisoprene rubber; an acrylate-butadiene rubber; a polychloroprene rubber; an acrylate-isoprene rubber; an ethylene-vinyl acetate rubber; a polypropylene oxide rubber; a polypropylene sulfide rubber; a fluoroelastomer; a perfluoroelastomer; or a thermoplastic polyurethane rubber; and
the functionalized silsesquioxane has a viscosity of about 1 poise to about 2000 poise at 25° C.

17. The method of claim 16, wherein the dispersion is combined with the elastomer and a crosslinking agent.

18. The method of claim 16, wherein the method further comprises crosslinking the functionalized silsesquioxane and the elastomer.

19. The method of claim 17, wherein the crosslinking agent comprises one or more of the following: sulfur; a sulfur donor; silica; a quinone; a peroxy compound; a metal oxide, a metal peroxide, or a metal salt.

20. A method of inhibiting flow comprising employing one or more of the downhole article of claim 1.

21. The method of claim 20, comprising deploying the downhole article in a downhole environment.
